(19) United States
(12) Patent Application Publication
(10) Pub. No.: US 2013/0148528 A1
(43) Pub. Date: Jun. 13, 2013

(54) ADAPTIVE MODULATION AND CODING SCHEME SELECTION METHOD AND APPARATUS

(71) Applicant: Samsung Electronics Co., Ltd., Gyeonggi-do (KR)

(72) Inventors: Jaeyun Ko, Gyeonggi-do (KR); Heewon Kang, Gyeonggi-do (KR); Kwanhee Roh, Gyeonggi-do (KR); Sungwoo Park, Gyeonggi-do (KR); Sungho Lee, Seoul (KR); Inseok Hwang, Gyeonggi-do (KR)

(73) Assignee: Samsung Electronics Co., Ltd., Gyeonggi-do (KR)

(21) Appl. No.: 13/709,978

(22) Filed: Dec. 10, 2012

(30) Foreign Application Priority Data
Dec. 8, 2011 (KR) 10-2011-0131170

(51) Int. Cl. H04W 24/02

(52) U.S. Cl. CPC H04W 24/02
USPC 370/252

(57) ABSTRACT

A method and apparatus are provided for selecting a Modulation and Coding Scheme (MCS). Interference strength information is received from one or more neighbor base stations. An interference level is estimated using the received interference strength information. The MCS is selected based the estimated interference level.

### PRIORITY

The application claims priority under 35 U.S.C. §119(a) to an application filed in the Korean Intellectual Property Office on Dec. 8, 2011, and assigned Serial No. 10-2011-0131170, the contents of which are incorporated herein by reference.

### BACKGROUND OF THE INVENTION

1. Field of the Invention

The present invention relates generally to mobile communication systems, and more particularly, to a method and apparatus for selecting a Modulation and Coding Scheme (MCS) in accordance with a channel condition.

2. Description of the Related Art

In a mobile communication system, individual user terminals have different Signal to Interference and Noise Ratios (SINRs). Each user terminal selects an MCS based on the SINR, and transmits data according to the MCS. Accordingly, the user terminal is capable of maximizing the data rate, while maintaining a data error rate that is below a predetermined level.

The SINR is calculated based on a signal strength and a noise strength. In a conventional method, the base station estimates the current signal strength using the previously received uplink pilot or sounding reference signal. The base station also estimates a current Noise and Interference (NI) using a previously measured NI value.

When a terminal is fixed or moving at a low speed, channel variation is significant. If the channel variation is not significant, the signal strength of the terminal does not vary much with time. Accordingly, a previously measured signal strength and a future signal strength are likely to be similar.

However, the NI strength varies according to locations and transmission powers of terminals in neighbor cells. By acknowledging that user terminals to be scheduled are changing in every frame, the NI strength may vary significantly in every frame.

Thus, although the signal strength is estimated accurately, the SINR estimation offset increases according to the variation of the NI strength. If the SINR estimation offset increases, the MCS has to be selected in a conservative manner so that the data error rate is maintained below an intended level. The base station in incapable of efficiently configuring the data rate.

### SUMMARY OF THE INVENTION

The present invention has been made to address at least the above problems and/or disadvantages and to provide at least the advantages described below. Accordingly, an aspect of the present invention provides an MCS configuration method and apparatus that is capable of configuring the data rate efficiently while maintaining the data error rate below a predetermined level.

In accordance with an aspect of the present invention, an MCS selection method of a base station is provided. Interference strength information is received from one or more neighbor base stations. An interference level is estimated using the received interference strength information. The MCS is selected based the estimated interference level.

In accordance with another aspect of the preset invention, a base station for selecting an MCS is provided. The base station includes a communication unit that receives interference strength information from one or more neighbor base stations.

The base station also includes an interference level calculator that estimates an interference level using the received interference strength information. The base station further includes an MCS allocator that selects an MCS based on the estimated interference level.

### BRIEF DESCRIPTION OF THE DRAWINGS

The above and other aspects, features and advantages of the present invention will be more apparent from the following detailed description when taken in conjunction with the accompanying drawings, in which:

FIG. 1 is a diagram illustrating the network architecture of the mobile communication system, according to an embodiment of the present invention;

FIG. 2 is a block diagram illustrating the configuration of a base station, according to an embodiment of the present invention; and

FIG. 3 is a signal flow diagram illustrating the MCS selection procedure of the base station, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

The modulation and coding scheme configuration method and apparatus, according to an embodiment of the present invention, is described hereinafter with reference to accompanying drawings.

Advantages and features of embodiments of the present invention and methods of accomplishing the same may be understood more readily by reference to the following detailed description and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art.

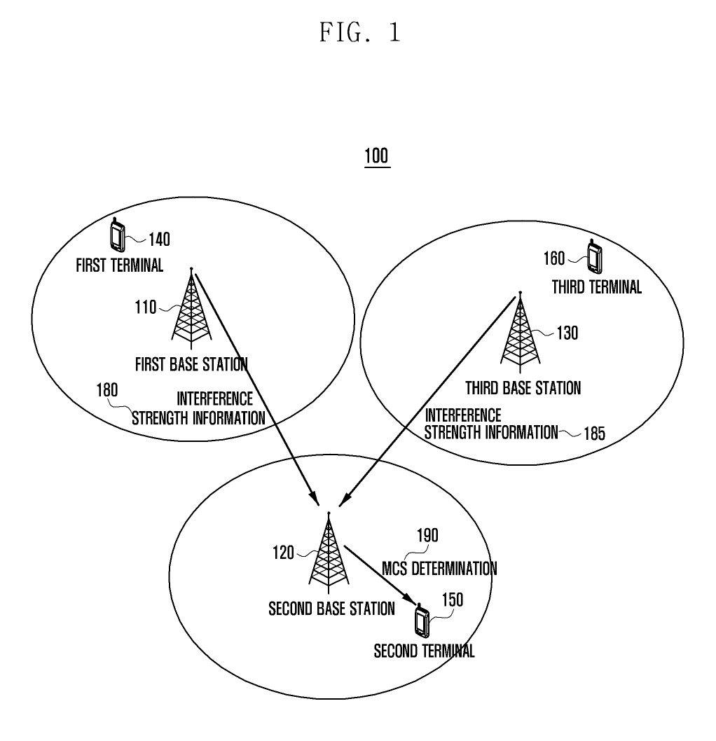

FIG. 1 is a diagram illustrating the network architecture of the mobile communication system, according to an embodiment of the present invention.

Referring to FIG. 1, a mobile communication system 100 includes a first base station 110, a second base station 120, a third base station 130, a first terminal 140, a second terminal 150, and a third terminal 160. The third base station 130 and the second base station 120 are close to each other. The first base station 110 is the serving base station of the first terminal 140. The second base station 120 is the serving base station of the second terminal 150. The third base station 130 is the serving base station of the third terminal 160.

The first base station 110 measures the noise and interference strength (hereinafter, referred to as ‘interference strength’), which the first terminal 140 influences on the second base station 120. The first base station 110 sends interference strength information 180 about the measured interference strength to the second base station 120. Likewise, the third base station 130 measures the interference strength caused by the third terminal 160 and sends interference strength information 185 to the second base station 120. The second base station 120 estimates an SINR based on the received interference strength information 180 and 185, and determines an MCS level 190 to be applied to the second terminal 150 based on the estimation result.

In the embodiment of FIG. 1, it is assumed that the first and third base stations 110 and 130 transmit the interference strength information 180 and 185, and the second base station 120 receives the interference strength information 180 and 185. In a real system, however, the second base station 120 may transmit the interference information to the first and second base stations 110 and 130. Specifically, the base stations 110, 120, and 130 can exchange the interference strength information among each other.

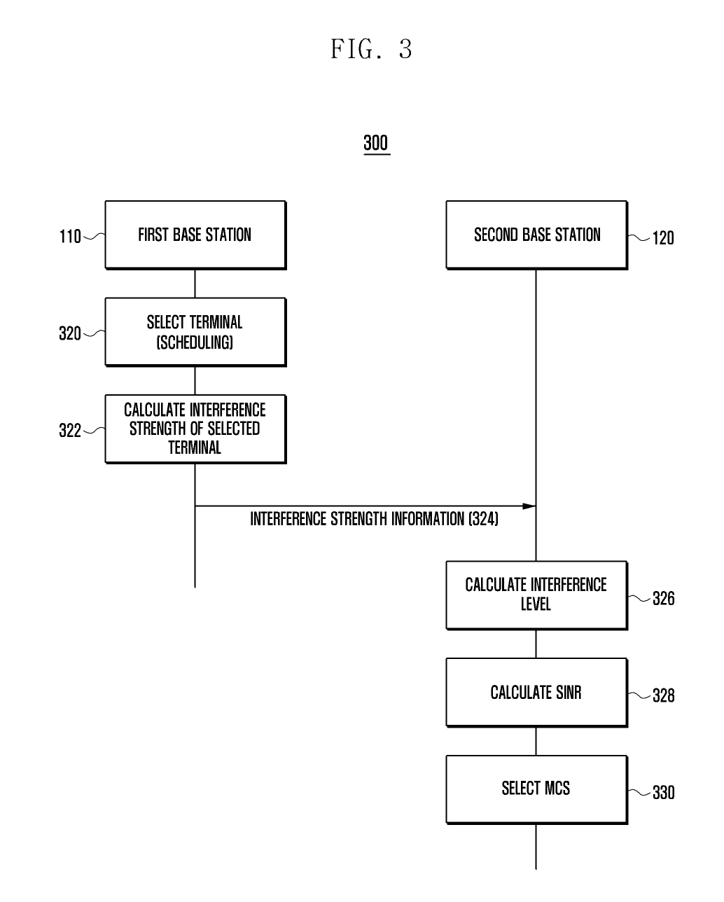

In the following description, neighbor base stations are base stations that exchange interference strength information. That is, since the first and third base stations 110 and 130 are exchanging the interference information 180 and 185 with the second base station 120, the first and third base stations 110 and 130 are neighbor base stations of the second base station 120. A determination of neighbor base stations is described in greater detail below with reference to FIG. 3.

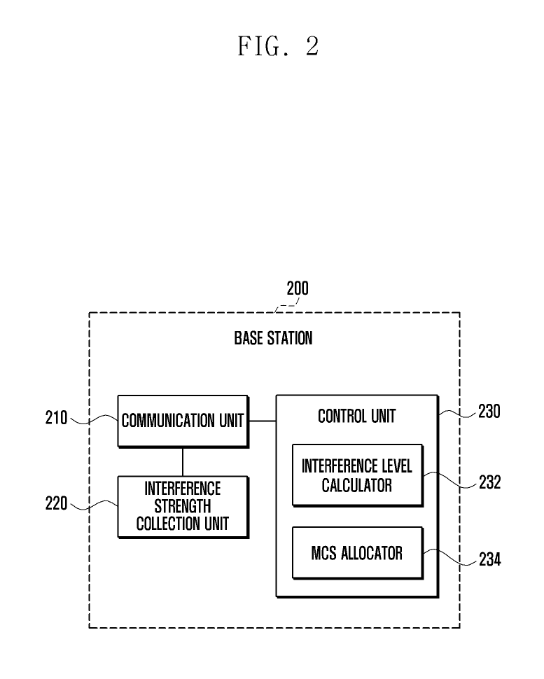

A modulation and coding scheme determination procedure is described in detail below, with reference to FIGS. 2 and 3.

FIG. 2 is a block diagram illustrating the configuration of a base station, according to an embodiment of the present invention. The base stations 110, 120, and 130 can be configured as depicted in FIG. 2.

Referring to FIG. 2, a base station 200, according to an embodiment of the present invention, includes a communication unit 210, an interference strength collection unit 220, and a control unit 230.

The interference strength collection unit 220 collects information on the interference strength of the terminal served by the base station 200, which influences the neighbor base stations. The collection of the interference strength information is described in greater detail below, with reference to FIG. 3.

The communication unit 210 is responsible for communication with the neighbor base station and the terminal. Particularly, the communication unit 210 transmits the collected interference strength information to the corresponding neighbor base station. The communication unit 210 also receives the interference strength information transmitted by the neighbor base stations and transmits the received information to the control unit 230. A determination of the neighbor base stations is described in greater detail below, with reference to FIG. 3.

The control unit 230 includes an interference level calculator 232 and an MCS allocator 234.

The interference level calculator 232 estimates the NI level (hereinafter, referred to as interference level). The interference level is the interference strength to the communication of the base station 200, which is estimated in consideration of the interference strength information received from the neighbor base stations.

The MCS allocator 234 allocates an MCS level appropriate for the corresponding terminal based on the interference level estimation result. The allocated MCS level can be notified to the corresponding terminal by means of the communication unit 210. The corresponding terminal performs modulation and coding according to the received MCS level.

FIG. 3 is a signal flow diagram illustrating the MCS selection procedure of the base station, according to an embodiment of the present invention.

FIG. 3 is directed to the operations of the first and second base stations 110 and 120 of FIG. 1. The description is made under the assumption that the first and second base stations 110 and 120 are configured as shown in FIG. 2. However, the first and second base stations 110 and 120 may not include non-essential components of the base station 200 of FIG. 2.

The control unit 230 of the first base station 110 selects a user terminal, in step 320. The first base station 110 selects the user terminal according to a scheduling policy using, for example, a conventional scheduling method. The scheduling method is not limited to the description of this embodiment. If the scheduling is complete, the user terminal, to which the base station transmits data, is determined.

The interference strength collection unit 220 of the first base station 110 calculates the interference strength to a neighbor base station, which is caused by the selected terminal, in step 322. It is assumed that the second base station 120 is the neighbor base station of the first base station 110. Equation (1) defines the interference strength Inf(k, j) from a terminal k to a neighbor base station j.

Inf(k, j)=P_{—}tx(k)×10^{-0.1PL(k,j)} (1)

P_tx(k) is the transmission power of the terminal k, and PL(k, j) denotes the Path Loss (dB) of the terminal k to the neighbor base station j.

Although only the first and second base stations 110 and 120 are depicted in the embodiment of FIG. 3 for purposes of simplicity, the first base station 110 may have other base stations in a real system. The first base station 110 calculates the interference strength caused by the selected terminal k to the neighbor base stations. A set of neighbor base stations can be configured by the operator in advance. According to an alternative embodiment of the present invention, the base stations within a predetermined distance from the first base station 110 can be the neighbor base stations of the first base station 110. The first base station 110 is capable of calculating the interference to the neighbor base station, which is caused by the selected terminal k. According to another alternative embodiment of the present invention, N base stations closest to the first base station 100 can be the neighbor base stations of the first base station 110. N may be defined as a preset value or a variable determined dynamically.

The first base station 110 is capable calculating the interference strength caused by the selected terminal k to the neighbor base stations. According to another alternative embodiment of the present invention, the first base station 110 is capable of receiving the information on the neighbor base station from the terminal to establish a set of neighbor base stations based on the neighbor base station information, and calculating the interference strength caused by the selected terminal k to the base station included in the neighbor base station set.

The first base station 110 sends the interference information to the second base station 120, in step 324. The interference strength information is the information on the interference strength calculated, in step 322. FIG. 3 is directed to an embodiment in which the first base station 110 transmits the interference strength information to the second base station 120 for purposes of simplicity. However, the base stations, including the first and second base stations 110 and 120, can exchange the interference strength information among each other in the system.

The first base station 110 is also capable of transmitting the interference strength information to neighbor base stations other than the second base station 120. The second base station 120 is also capable of transmitting the interference strength information to another neighbor base station of the first base station 110. The second base station 120 is capable of receiving the interference strength information from other base stations in addition to the first base station 110.

The second base station 120 calculates the interference level based son the interference strength information received from the neighbor base stations, in step 326.

The interference level NI(i, t) to the base station i at frame t can be calculated according to Equation (2). The interference level calculator 232 of the second base station 120 is capable of calculating the interference level according to Equation (2). The interference level calculator 232 is also capable of calculating the interference level using an alternative equation modified from Equation (2). The interference level calculator 232 is also capable of calculating the interference level in another way based on the received interference strength information.

$$NI ( i , t ) = {\sum }_{j ∈ Nbr ( i )} Inf ( {π}_{j , t} , i ) + NI\_other ( i , t ) \qquad ( 2 )$$

π_{j,t} denotes the terminal selected by the base station j at frame t. As described above, the neighbor base stations of the second base station 120 calculate the interference strength Inf(π_{j,t}, i) using Equation (1) (step 322) and transmit the calculated interference strength to the second base station 120 (step 326). Nbr(i) denotes the set of the neighbor base stations of the base station i. The neighbor base stations can be selected according to a neighbor base station configuration method that is similar or identical to the method described with reference to step 322.

The interference strength compensation value NI_other(i, t) denotes a sum of the interference caused by base stations other than Nbr(i) at frame t and thermal noise. The interference level calculator 232 of the second base station 120 estimates NI_other(i, t) according to Equation (3).

NI_other(i,t)=α×NI_other(i,t−1)+(1−α)×NI_other_inst(i,t−1) (3)

α denotes a variable for use in estimating NI_other(i, t) and has a value greater than or equal to 0 and less than or equal to 1. The instant interference strength NI_other_inst(i, t−1) denotes the sum of the interference strength of the cell other than Nbr(i) estimated at frame t−1 of the base station i and thermal noise. NI_other_inst(i, t−1) is calculated by Equation (4).

$$NI\_other \_inst ( i , t - 1 ) = NI\_esti ( i , t - 1 ) - {\sum }_{j ∈ Nbr ( i )} Inf ( {π}_{j , t - 1} , i ) \qquad ( 4 )$$

NI_esti(i, t−1) denotes the interference level measured by cell i at frame t−1. NI_esti(i, t−1) is differentiated from the NI(i, t−1) estimated with Equations (2) to (4). Specifically, NI_esti(i, t−1) is the interference level measured accurately other than an estimated interference level.

In summary, the interference level NI(i, t) is estimated in the procedure as follows:

1-i) measure the Interference level NI_esti(i, t−1) at frame t−1

1-ii) extract the value acquired by subtracting the sum of the interference strengths received from neighbor base stations at frame t−1 from NI_esti(i, t−1) as instant interference strength NI_other_inst(i, t−1) at frame t−1 (equation (4)).

1-iii) estimate the interference strength compensation value NI_other(i, t) at frame t by applying weights α and 1−α to the respective interference strength compensation value NI_other(i, t−1) and instant interference strength NI_other_instant(i, t−1) at frame t−1 (equation (3)).

1-iv) estimate the interference level NI(i, t) at frame t by adding the interference strength compensation value NI_other(i, t) at frame t to the sum of the interference strengths received from the neighbor base stations at frame t (equation (2)).

Equations (2) to (4) can be replaced by other equations that output substantially the same or a similar result. For example, it is possible to replace the operation of adding the interference strength compensation value NI_other(i, t) to the sum of the received signal strengths at frame t with the operation of applying weights to the sum of the received interference strengths and the interference strength compensation value NI_other(i, t) at frame t and then adding the weighted NI_other(i, t) to the weighted sum of the received signal strengths.

Equations (2) to (4) can be generalized as follows:

2-i) measure the interference level of the base station at frame t−1.

2-ii) extract instant interference strength at frame t−1 using the interference level measured at frame t−1 and sum of the interference strengths received from the neighbor base stations at frame t−1.

2-iii) extract interference strength compensation value at frame t using the interference compensation value extracted at frame t−1 and the instant interference strength at frame t−1.

2-iv) estimate interference level at frame t using the interference strength compensation value at frame t and the interference strength information received form the neighbor base stations at frame t.

Steps 1-i) to 1-iv) show one of the special cases of the general procedure of steps 2-i) to 2-iv). Typically, the procedure of 2-i) to 2-iv) can be performed with modified Equations (2) to (4).

When several frequency bands exist in one frame to which different users are designated, the interference level can be calculated per frequency band.

The MCS allocator 234 of the second base station 120 estimates the Signal to Interference ratio SINR(k, t) at frame t using the estimated interference level NI(i, t). The SINR(k, t) is the signal to interference plus noise ratio for use in the communication with the terminal k at frame t. The SINR(k, t) can be calculated by a method based on Equations (2) to (4), or a similar method using the estimated interference level NI(i, t) and signal strength S(k, t). The signal strength S(k, t) can be acquired through well-known methods using the previously measured signal strength of terminal k or previously received uplink pilot or sounding reference signal. In order to calculate SINR(k, t) using the estimated interference level NI(i, t) and signal strength S(k, t), it is possible to use the conventionally disclosed techniques or other similar techniques. For example, the SINR(k, t) can be calculated using Equation (5):

SINR(k, t)=S(k, t)/NI(i, t) (5)

S(k, t) denotes the signal strength of terminal k at frame t, and NI(i, t) denotes the interference level of the base station I at frame t, which has been estimated using Equations (2) to (4), or a similar method.

The MCS allocator 234 of the second base station 120 determines the MCS to be applied to the terminal k according to the estimated SINR(k, t), in step 330. In order to maintain the Packet Error Rate (PER), a required SINR exists per MCS level. This depends on the reception capability of the base station. The SINR required for MCS level m is referred to as SINR_req(m). The selected MCS, MCS_sel, can be acquired using Equation (6).

MCS_{—}sel=arg max {SINR(k, t)≧SINR_{—}req(m)} (6)

Among the MCS levels fulfilling the condition that the SINR_req(m) is less than the SINR estimation value, SINR(k, t), the greatest one is selected as MCS_sel. The MCS level selected in this way is transmitted to the terminal such that the terminal performs modulation and coding according to the received MCS level.

In the embodiment of the present invention illustrated in FIG. 3, it is assumed that the second base station 120 receives the interference strength information in step 324. However, alternative embodiments of the present invention can be considered in which the second base station 120 does not receive entire interference strength information, or some neighbor base stations fail to transmit the interference strength information in step 324.

According to an alternative embodiment of the present invention, in a situation in which the interference strength information is not received entirely in step 324, the second base station 120 is capable of using the interference level NI(i, t−1) estimated at previous frame t−1 instead of NI(i, t). Meanwhile, when some of the neighbor base stations fail transmit interference strength information, the interference strength information that has been transmitted by the corresponding base stations can be used.

As described above, the MCS configuration method and apparatus of the present invention is capable of efficiently determining the data rate while maintaining the data error rate below a predetermined level.

It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Furthermore, the respective block diagrams may illustrate parts of modules, segments or codes including at least one or more executable instructions for performing specific logic function(s). Moreover, it should be noted that the functions of the blocks may be performed in a different order in several modifications. For example, two successive blocks may be performed substantially at the same time, or may be performed in reverse order according to their functions. The term “module” according to the embodiments of the present invention, means, but is not limited to, a software or hardware component, such as a Field Programmable Gate Array (FPGA) or Application Specific Integrated Circuit (ASIC), which performs certain tasks. A module may advantageously be configured to reside on the addressable storage medium and may be configured to be executed on one or more processors. Thus, a module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided for in the components and modules may be combined into fewer components and modules or further separated into additional components and modules. In addition, the components and modules may be implemented such that they execute one or more CPUs in a device or a secure multimedia card.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

Although embodiments of the present invention have been described in detail hereinabove with specific terminology, this is for the purpose of describing particular embodiments only and not intended to be limiting of the invention. While embodiments of the present invention have been illustrated and described, it will be understood by those skilled in the art that various changes in form and detail may be made therein without departing from the spirit and scope of the invention as defined by the appended claims.

What is claimed is:

1. A Modulation and Coding Scheme (MCS) selection method of a base station, the method comprising the steps of:
receiving interference strength information from one or more neighbor base stations;
estimating an interference level using the received interference strength information; and
selecting the MCS based the estimated interference level.

2. The MCS selection method of claim 1, wherein estimating the interference level comprises:
measuring the interference level of the base station at a previous frame;
acquiring an instant interference strength at the previous frame using the interference level measured at the previous frame and a sum of interference strengths received from the one or more base stations at the previous frame;
extracting an interference strength compensation value at a present frame using an interference strength compensation value acquired at the previous frame and the instant interference strength at the previous frame; and
estimating the interference level using the interference strength compensation value at the present frame and the received interference strength information from the one or more neighbor base stations at the present frame.

3. The MCS selection method of claim 1, wherein estimating the interference level comprises:
measuring the inference level of the base station at a previous frame;
acquiring a value, which is obtained by subtracting a sum of interference strengths received from the one or more neighbor base stations at the previous frame from the interference level measured at the previous frame, as an instant interference strength;
calculating an interference strength compensation value at the present frame by applying weights to an interference strength compensation value estimated at the previous frame and the instant interference strength at the previous frame; and
estimating the interference level by adding the sum of the interference strengths of the one or more neighbor base stations acquired from the interference strength information received at the present frame to the interference strength compensation value at the present frame.

4. The MCS selection method of claim 1, wherein selecting the MCS comprises:
estimating a Signal to Interference and Noise Ratio (SINR) using the estimated interference level and a signal strength of a terminal; and
selecting the MCS using the estimated SINR.

5. The MCS selection method of claim 1, wherein each of the one or more neighbor base stations selects a terminal, acquires an interference strength caused by the selected terminal to the base station, and transmits information on the acquired interference strength to the base station.

6. The MCS selection method of claim 1, further comprising, when the interference strength information is not received from any of the one or more neighbor base stations at a present frame, selecting the MCS using an interference level estimated at a previous frame.

7. The MCS selection method of claim 1, further comprising, when the interference strength information is not received from some of the one or more neighbor base stations at a present frame, selecting the MCS using interference strength information received at a previous frame from the some of the one or more neighbor base stations that failed transmission at the present frame.

8. A base station for selecting a Modulation and Coding Scheme (MCS), the base station comprising:
a communication unit that receives interference strength information from one or more neighbor base stations;
an interference level calculator that estimates an interference level using the received interference strength information; and
an MCS allocator that selects the MCS using the estimated interference level.

9. The base station of claim 8, wherein the interference level calculator measures the interference level of the base station at a previous frame, acquires an instant interference strength at the previous frame using the interference level measured at the previous frame and a sum of interference strengths received from the one or more base stations at the previous frame, extracts an interference strength compensation value at a present frame using an interference strength compensation value acquired at the previous frame and the instant interference strength at the previous frame, and estimates the interference level using the interference strength compensation value at the present frame and the received interference strength information from the one or more neighbor base stations at the present frame.

10. The base station of claim 8, wherein the interference level calculator measures the inference level of the base station at a previous frame, acquires a value, which is obtained by subtracting a sum of interference strengths received from the one or more neighbor base stations at the previous frame from the interference level measured at the previous frame, as an instant interference strength, calculates an interference strength compensation value at the present frame by applying weights to an interference strength compensation value estimated at the previous frame and the instant interference strength at the previous frame, and estimates the interference level by adding the sum of the interference strengths of the one or more neighbor base stations acquired from the interference strength information received at the present frame to the interference strength compensation value at the present frame.

11. The base station of claim 8, wherein the MCS allocator estimates a Signal to Interference and Noise Ratio (SINR) using the estimated interference level and a signal strength of a terminal and selects the MCS using the estimated SINR.

12. The base station of claim 8, wherein each of the one or more neighbor base stations selects a terminal, acquires an interference strength caused by the selected terminal to the base station, and transmits information on the acquired interference strength to the base station.

13. The base station of claim 8, wherein, when the interference strength information is not received from any of the one or more neighbor base stations at a present frame, the MCS allocator selects the MCS using an interference level estimated at a previous frame.

14. The base station of claim 8, wherein, when the interference strength information is not received from some of the one or more neighbor base stations at a present frame, the MCS allocator selects the MCS using interference strength information received at a previous frame from the some of the one or more neighbor base stations that failed transmission at the present frame.
